(19) United States
(12) Patent Application Publication
(10) Pub. No.: US 2004/0120077 A1
(43) Pub. Date: Jun. 24, 2004

(54) Method and apparatus for improving the design and manufacturing process of a hard disk drive magnetic head arm assembly by welding specific components

(76) Inventors: Ming Gao Yao, Dongguan City (CN); Masashi Shiraishi, Kowloon (HK); Yi Ru Xie, Dongguan City (CN)

Correspondence Address: KENYON & KENYON, Suite 600, 333 W. San Carlos, Street, San Jose, CA, 95110-2711, US

(21) Appl. No.: 10/634,269

(22) Filed: Aug. 5, 2003

(30) Foreign Application Priority Data
Oct. 9, 2002 (WO) PCT/CN02/00713

(51) Int. Cl. G11B 5/48

(52) U.S. Cl. 360/244.5

(57) ABSTRACT

A system and method for improving the design and manufacturing process of a hard disk drive magnetic head arm assembly (HAA) by welding specific components is disclosed.

### BACKGROUND INFORMATION

The present invention relates to magnetic hard disk drives. More specifically, the present invention relates to a system for an improved magnetic head arm assembly (HAA).

Among the better known data storage devices are magnetic disk drives of the type in which a magnetic head slider assembly floats on an air bearing at the surface of a rotating magnetic disk. Such disk drives are often called ‘Winchester’-type drives. In these, one or more rigid magnetic disks are located within a sealed chamber together with one or more magnetic head slider assemblies. The magnetic disk drive may include one or more rigid magnetic disks, and the slider assemblies may be positioned at one or both sides of the magnetic disks.

FIG. 1 provides an illustration of a typical hard drive as used in the art. The slider assembly 104 may be mounted in a manner which permits gimbaled movement at the free outer end of the arm 102 such that an air bearing between the slider assembly 104 and the surface of the magnetic disk 106 can be established and maintained. The drive arm 102 is coupled to an appropriate mechanism, such as a voice-coil motor (VCM) 108, for moving the arm 102 across the surface of the disk 106 so that a magnetic head contained within the slider assembly 104 can address specific concentric data tracks on the disk 106 for writing information on to or reading information from the data tracks.

Because of the decreasing scale of hard drive components and the demand for increased hard drive capacity, the minimization of manufacturing tolerances and consistency of assembly have become a large priority. The coupling of certain hard drive components by materials such as adhesives causes difficulty with regards to manufacturing complexity and quality control. Common adhesives utilized in hard drive assembly include anisotropic conductive film (ACF), anisotropic conductive adhesive (ACA), and epoxy. These adhesives have disadvantages such as being susceptible to changes in temperature and humidity. For example, as viscosity changes under heat, parts can shift from their desired position. Also, the softness of the adhesive makes it difficult to work with (e.g., positioning, cutting an accurate size piece, etc.). Further, adhesives are susceptible to particle and chemical (ion) contamination. Still further, adhesives typically provide poor electrical conduction properties necessary to discharge electrostatic build-up. It is therefore desirable to have a system and method for improving the manufacture of hard disk drive arm assemblies that avoids the above-mentioned problems, in addition to other advantages.

### BRIEF DESCRIPTION OF THE DRAWINGS

FIG. 1 provides an illustration of a typical hard drive as used in the art.

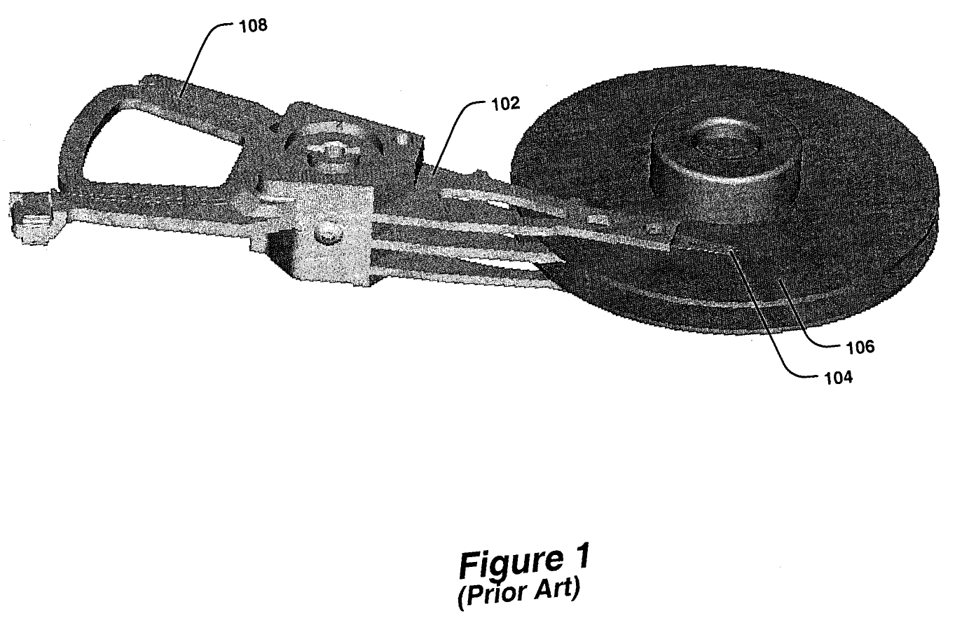

FIG. 2 illustrates two methods of welding hard drive components according to an embodiment of the present invention.

FIG. 3 illustrates two additional methods of welding hard drive components according to an embodiment of the present invention.

FIG. 4 provides an illustration of a head suspension with an attached slider according to an embodiment of the present invention.

FIG. 5 provides an illustration of a head suspension with a micro-actuated slider according to an embodiment of the present invention.

FIG. 6 provides an illustration of the attachment of head suspension to hard drive arm according to an embodiment of the present invention.

FIG. 7 provides an illustration of the attachment of hard drive flex cable to hard drive arm according to an embodiment of the present invention.

FIG. 8 provides an illustration of the attachment of hard drive flex cable to hard drive arm according to a different embodiment of the present invention.

FIG. 9 provides an illustration of the attachment of hard drive bridge flex circuit (BFC) to head suspension according to an embodiment of the present invention.

### DETAILED DESCRIPTION

To avoid the above-mentioned problems associated with the usage of materials such as adhesives in hard drive assembly, components are joined by different methods of welding under principles of the present invention.

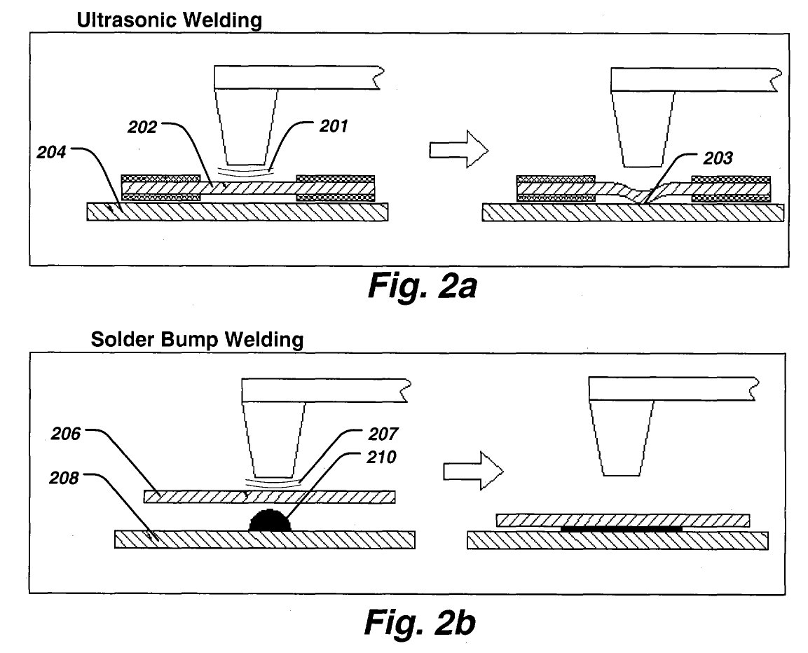

FIG. 2 illustrates two methods of welding hard drive components according to an embodiment of the present invention. Ultrasonic welding, illustrated in FIG. 2a, utilizes ultrasonic waves 201 to heat the components. In one embodiment, a first hard drive component 202 is fused 203 directly to a second hard drive component 204 by the heat. In this embodiment, the first and second components are metal such as copper or gold. Solder bump bond (SBB) welding, illustrated in FIG. 2b, utilizes a heat source such as ultrasonic waves 207 to heat the components. In an embodiment, the first hard drive component 206 is heated to a point at which a solder ‘bump’ (ball) 210, attached to the second component 208, is melted, joining the first and second components upon cooling. In an alternative embodiment, the first hard drive component is heated to a point at which a solder ‘bump’ (ball), attached to the first component, is melted, joining the first and second components upon cooling (configuration not shown).

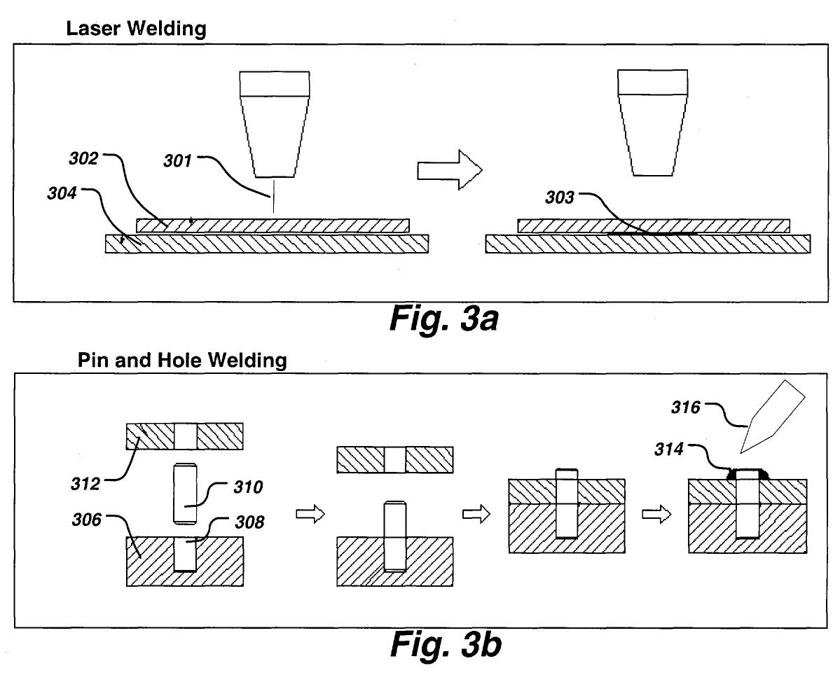

FIG. 3 illustrates two more methods of welding hard drive components according to an embodiment of the present invention. Laser welding, illustrated in FIG. 3a, utilizes a laser beam 301 to heat the components. In one embodiment, a first hard drive component 302 is fused 303 directly to a second hard drive component 304 by the heat. In this embodiment, the first and second components are metal such as copper, gold, or stainless steel. ‘Pin and hole’ welding, illustrated in FIG. 3b, utilizes a welding pin that is inserted into a hole in each component. In an embodiment, the second hard drive component 306 has a cylindrical recession 308 in which a welding pin 310 is inserted. In this embodiment, the diameter of the recession 308, as compared to the diameter of the pin 310, is such that the pin 310 is coupled to the second component 306 by an interference fit (friction). In an alternative embodiment, the pin and hole each have a rectangular cross-section. In an embodiment, the first hard drive component 312 is coupled to the pin 310 by a solder bond of a material such as Tin, which is applied by a tool such as a soldering iron 316. In another embodiment, the second hard drive component and pin are formed as one piece during manufacture (not shown).

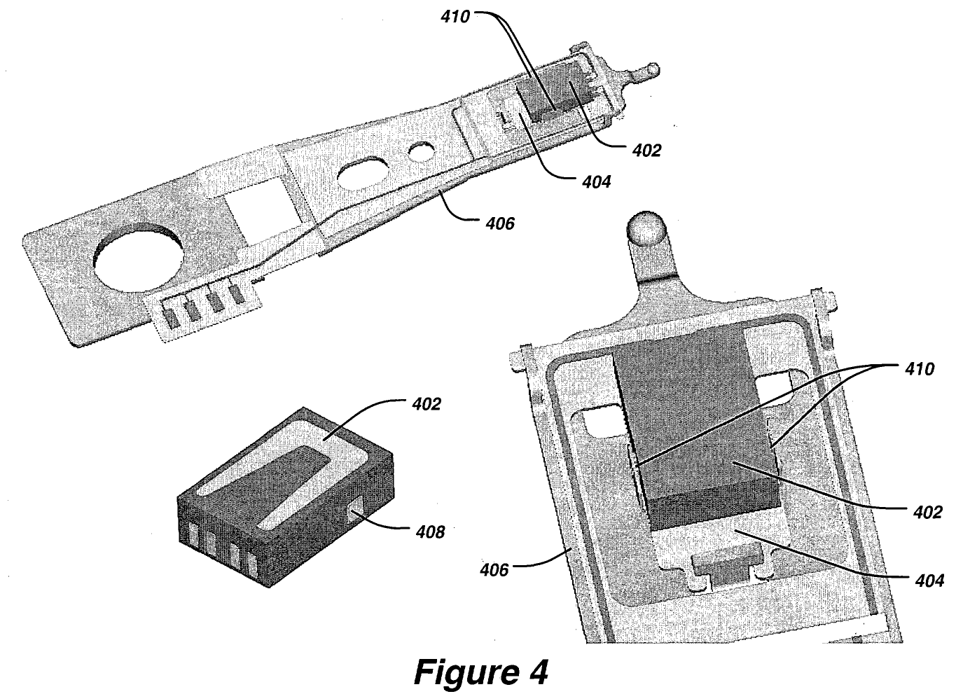

FIG. 4 provides an illustration of a head suspension with an attached slider according to an embodiment of the present invention. In one embodiment, the slider 402 is attached to the slider frame 404 of the head suspension (head gimbal assembly(HGA)) 406 by welds 410 between two welding pads 408 on the slider 402 and two tabs on the slider frame 404. In one embodiment, these welds are performed by ultrasonic welding. In another embodiment, the welds are performed by SBB welding. In a further embodiment, the welds are performed by laser welding.

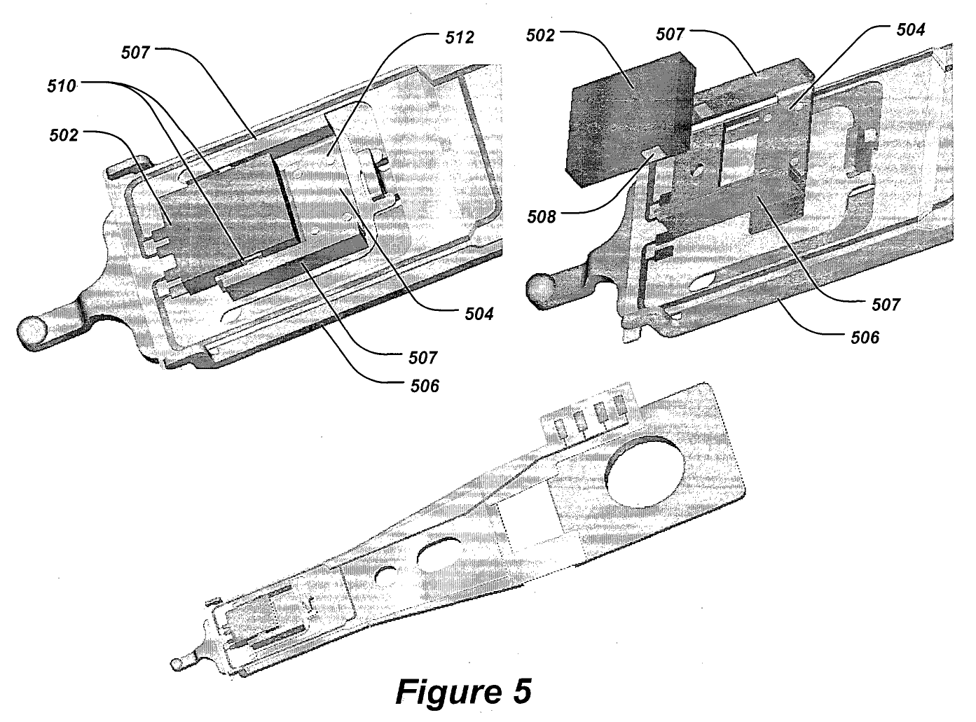

FIG. 5 provides an illustration of a head suspension with d micro-actuated slider according to an embodiment of the present invention. Similar to above, in one embodiment, the slider 502 is attached to the slider frame 504 of the head suspension 506 by welds 510 between two welding pads 508 on the slider 502 and the slider frame 504. Note that the slider frame 502 illustrated is for micro-actuation of the slider (whereas the slider frame 402 in FIG. 4 is not). Two piezoelectric arms 507 are utilized to minutely adjust the slider's position with respect to the head suspension 506 and hard drive arm (not shown). As above, in one embodiment, the welds are performed by ultrasonic welding; in another embodiment, the performed by SBB welding; and in a further embodiment, the welds are performed by laser welding.

In one embodiment of the present invention, the slider frame 504 is attached to suspension 506 via welding 512. As above, in one embodiment, the welds are performed by ultrasonic welding; in another embodiment, the welds are performed by SBB welding; and in a further embodiment, the welds are performed by laser welding.

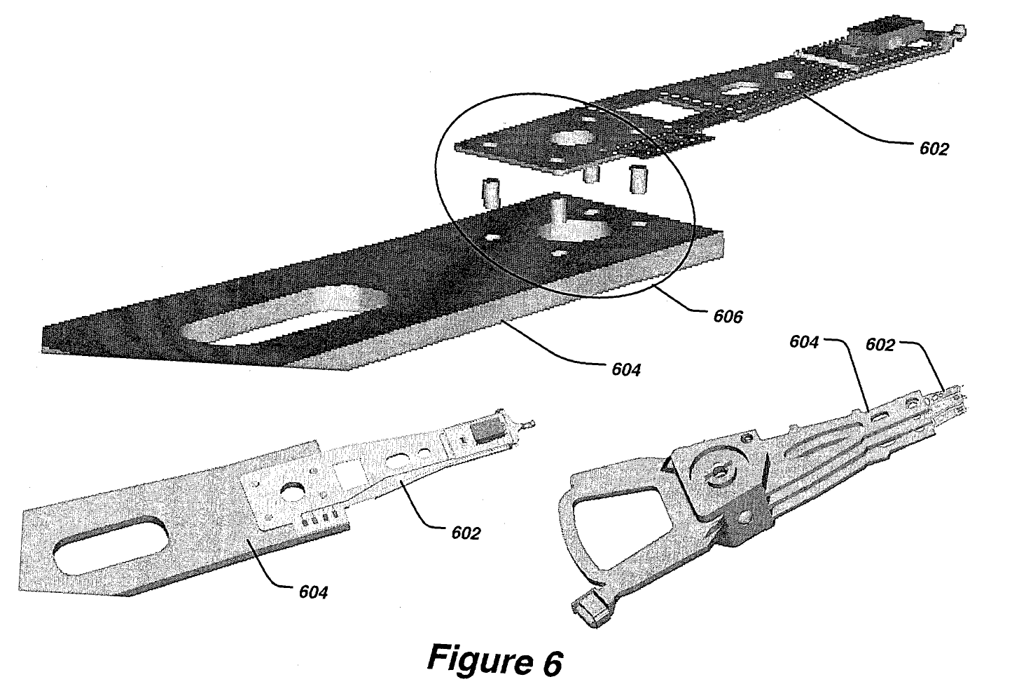

FIG. 6 provides an illustration of the attachment of head suspension to hard driver arm according to an embodiment of the present invention. In a preferred embodiment, the welds between head suspension 602 and hard drive arm 604 are performed by pin and hole welding 606. In another embodiment, the welds are performed by ultrasonic welding; in another embodiment, the welds are performed by SBB welding; and in a further embodiment, the welds are performed by laser welding.

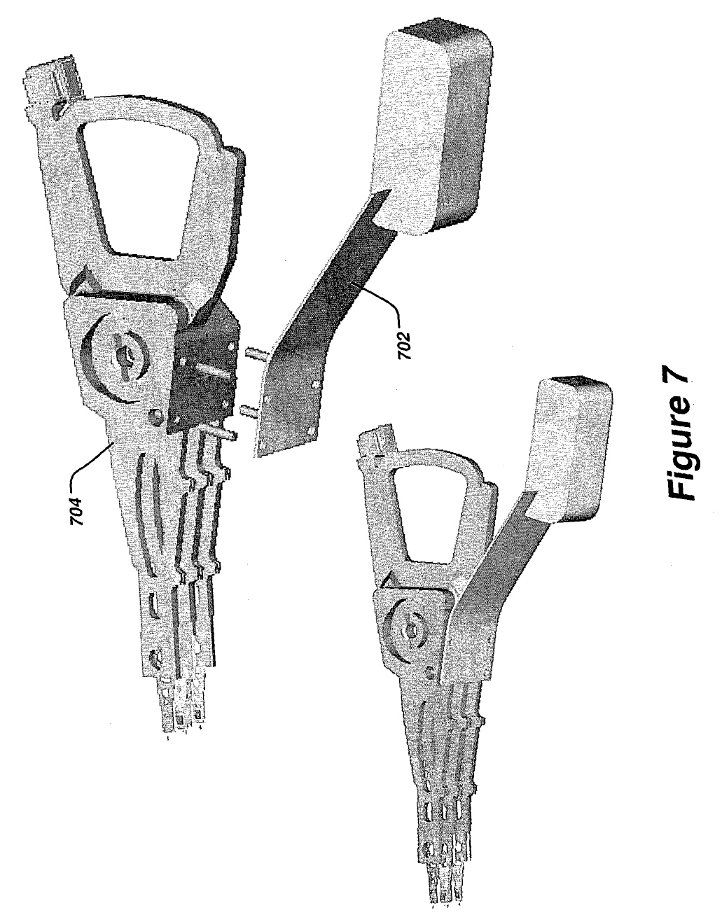

FIG. 7 provides an illustration of the attachment of hard drive flex cable to hard drive arm according to an embodiment of the present invention. In one embodiment, the welds between flex cable 702 and hard drive arm 704 are performed by pin and hole welding.

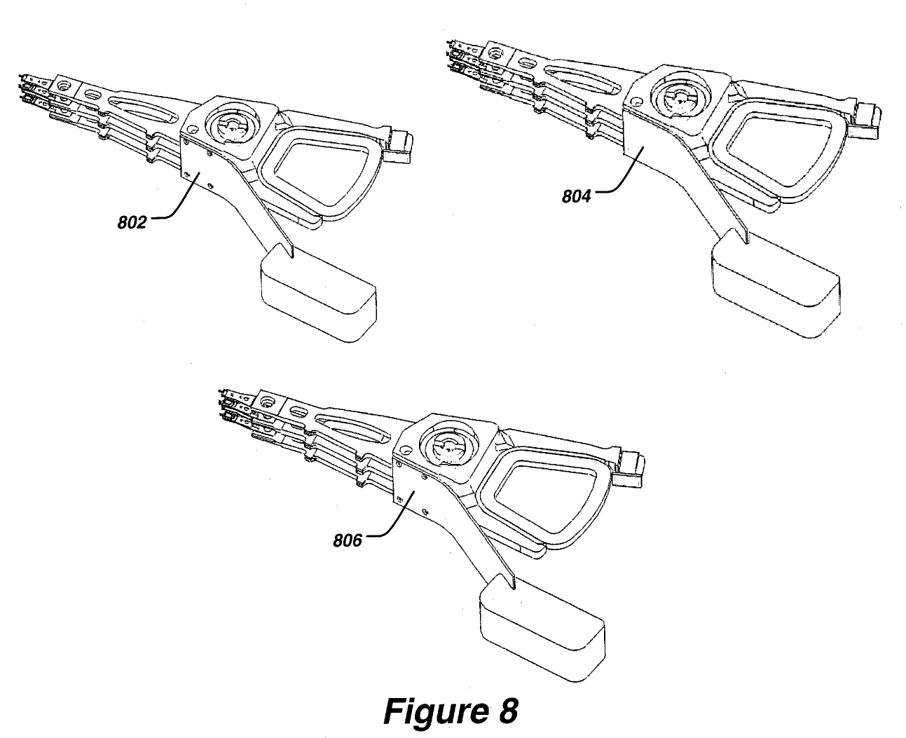

FIG. 8 provides an illustration of the attachment of hard drive flex cable to hard drive arm according to a different embodiment of the present invention. In one embodiment, the welds between flex cable and hard drive arm are performed by ultrasonic welding 802; in another embodiment, the welds are performed by SBB welding 804; and in a further embodiment, the welds are performed by laser welding 806.

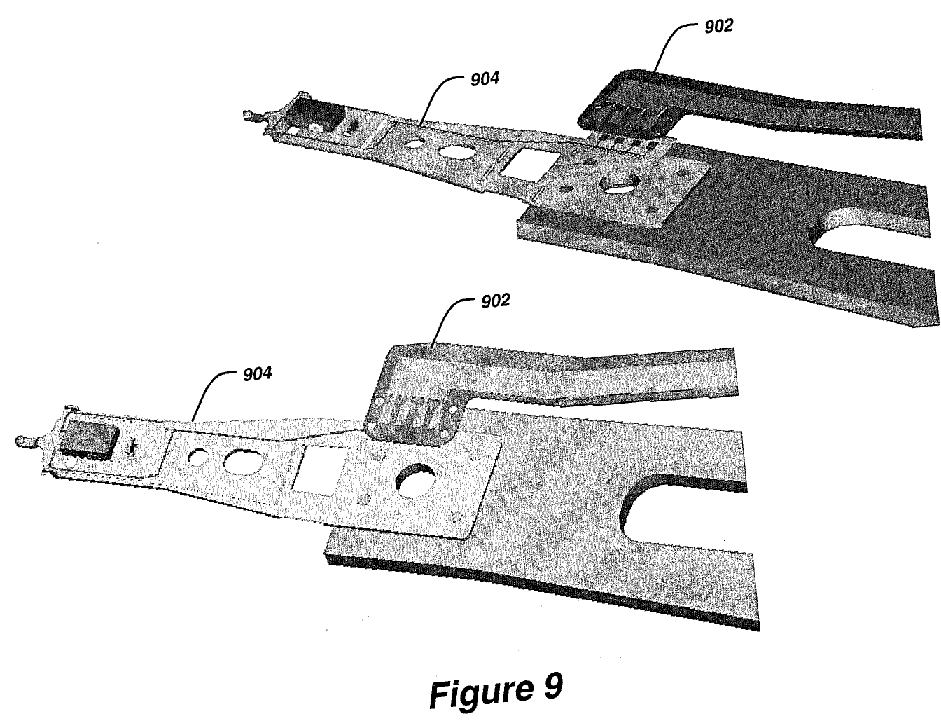

FIG. 9 provides an illustration of the attachment of bard drive bridge flex circuit (BFC) to head suspension according to an embodiment of the present invention. In one embodiment, the welds between BFC 902 and head suspension 904 are performed by ultrasonic welding; in another embodiment, the, welds are performed by SBB welding; and in a further embodiment, the welds are performed by laser welding.

Although several embodiments are specifically illustrated and described herein, it will be appreciated that modifications and variations of the present invention are covered by the above teachings and within the purview of the appended claims without departing from the spirit and intended scope of the invention.

1. A system for a magnetic head arm assembly (HAA) comprising:
a first component having a first cavity to be coupled to an arm portion having an arm cavity via a pin element welded between said first component and said arm portion, wherein
said first component is selected from the group consisting of a head suspension portion and a flex cable portion.

2. The system of claim 1, wherein said head suspension portion is a hard disk drive head gimbal assembly (HGA).

3. The system of claim 1, wherein said flex cable portion is a hard disk drive flex cable.

4. The system of claim 1, wherein said arm portion is a hard disk drive arm.

5. The system of claim 1, wherein said pin element is a copper welding pin.

6. The system of claim 1, wherein said pin element is inserted into said first cavity and into said arm cavity and said pin element to couple said first component to said arm portion.

7. The system of claim 6, wherein said pin element is cylindrical; said first cavity is a circular hole with a diameter enabling insertion of said pin element; and said arm cavity is a circular recession with a diameter enabling insertion of said pin element.

8. The system of claim 6, wherein said pin element has a rectangular cross-section; said first cavity is a rectangular opening with a size enabling insertion of said pin element; and said arm cavity is a rectangular recession with a size enabling insertion of said pin element.

9. The system of claim 6, wherein said pin element is interference fitted into said arm cavity and said pin element is soldered to first component to couple said first component to said arm portion.

10. A method for a magnetic head arm assembly (HAA) comprising:
coupling a first component having a first cavity to an arm portion having an arm cavity via a pin element welded between said first component and said arm portion, wherein
said first component is selected from the group consisting of a head suspension portion and a flex cable portion.

11. The method of claim 10, wherein said head suspension portion is a hard disk drive head gimbal assembly (HGA).

12. The method of claim 10, wherein said flex cable portion is a hard disk drive flex cable.

13. The method of claim 10, wherein said arm portion is a hard disk drive arm.

14. The method of claim 10, wherein said pin element is a copper welding pin.

15. The method of claim 10, wherein said pin element is inserted into said first cavity and into said arm cavity and said pin element to couple said first component to said arm portion.

16. The method of claim 15, wherein said pin element is cylindrical; said first cavity is a circular hole with a diameter enabling insertion of said pin element; and said arm cavity is a circular recession with a diameter enabling insertion of said pin element.

17. The method of claim 15, wherein said pin element has a rectangular cross-section; said first cavity is a rectangular opening with a size enabling insertion of said pin element; and said arm cavity is a rectangular recession with a size enabling insertion of said pin element.

18. The method of claim 15, wherein said pin element is interference fitted into said arm cavity and said pin element is soldered to first component to couple said first component to said arm portion.

19. A system for a magnetic head arm assembly (HAA) comprising:
a first component to be coupled to a second component via welding said first component to said second component, wherein
said first component is selected from the group consisting of a head suspension portion, a flex cable portion, and a flex circuit portion.
said second component is an arm portion.

20. The system of claim 19, wherein said first component is a hard disk drive slider frame and said second component is selected from a group consisting of a hard disk drive head gimbal assembly (HGA) and a hard disk drive slider.

21. The system of claim 19, wherein said head suspension portion is a hard disk drive head gimbal assembly (HGA).

22. The system of claim 19, wherein said flex cable portion is a hard disk drive flex cable.

23. The system of claim 19, wherein said flex circuit portion is a hard disk drive bridge flex circuit (BFC).

24. The system of claim 19, wherein said arm portion is a hard disk drive arm.

25. The system of claim 19, wherein said first component is coupled to said second component via a type of welding selected for the group consisting of ultrasonic welding, solder bump welding, and laser welding.

26. The system of claim 20, wherein said first component is coupled to said second component via a type of welding selected for the group consisting of ultrasonic welding, solder bump welding, and laser welding.

27. A method for a magnetic head arm assembly (HAA) comprising:
welding a first component to a second component, wherein
said first component is selected from the group consisting of a bead suspension portion, a flex cable portion, and a flex circuit portion.
said second component is an arm portion.

28. The method of claim 27, wherein said first component is a hard disk drive slider frame and said second component is selected from a group consisting of a hard disk drive head gimbal assembly (HGA) and a hard disk drive slider.

29. The method of claim 27, wherein said head suspension portion is a hard disk drive head gimbal assembly (HGA).

30. The method of claim 27, wherein said flex cable portion is a hard disk drive flex cable, said flex circuit portion is a hard disk drive bridge flex circuit (BFC), and said arm portion is a hard disk drive arm.

31. The method of claim 27, wherein said first component is coupled to said second component via a type of welding selected for the group consisting of ultrasonic welding, solder bump welding, and laser welding.

32. The method of claim 28, wherein said first component is coupled to said second component via a type of welding selected for the group consisting of ultrasonic welding, solder bump welding, and laser welding.
